(19) United States
(12) Patent Application Publication
(10) Pub. No.: US 2005/0051511 A1
(43) Pub. Date: Mar. 10, 2005

(54) Method for manufacturing chemical sensors

(76) Inventors: Wen-Wang Ke, Taipei (TW); Wen-Yang Chang, YunLin (TW); Yu-Sheng Hsieh, Taichung (TW); Nai-Hao Kuo, KaoHsiung (TW); Cheng-Hong Lee, Taipei (TW)

Correspondence Address: BIRCH STEWART KOLASCH & BIRCH, PO BOX 747, FALLS CHURCH, VA, 22040-0747, US

(21) Appl. No.: 10/745,594

(22) Filed: Dec. 29, 2003

(30) Foreign Application Priority Data
Sep. 9, 2003 (TW) 092124804

(51) Int. Cl. H01B 13/00; B05D 3/12

(52) U.S. Cl. 216/13; 427/289; 427/372.2

(57) ABSTRACT

A method for manufacturing chemical sensors is provided for the process of the wafer level chemical sensor. The method is to form a frame around a certain area on the chemical sensor for locating sensing material, and then to fill the Sol-Gel sensing material into the frame. Besides, the present invention further provides a method for dividing the chemical sensor chips employed in such wafer level chemical sensor. The character of such method is to stick an adhesion object such as blue tape on the backside of the substrate, and then to cut in advance a scribe line around the rim of the chemical sensor before filling the sensing material into the sensor. Finally, the plurality of the chemical sensors will be divided into individual ones after the process of calcining or furnacing.

### 1. FIELD OF THE INVENTION

The present invention relates to a method for manufacturing chemical sensors, in particular to a method for locating the sensing material onto the wafer level chemical sensor through a drip system. Moreover, the present invention also provides a method for dividing chemical sensor chips without damage the sensing material in the wafer level chemical sensor.

### 2. BACKGROUND OF THE INVENTION:

In the present day, there have been lots of chemical or gas sensors in wide use, such as Chemiresistors Sensors, Chemicapacitors Sensors, Chemomechanical Sensors, Calorimetric Sensors, Electrochemical Sensor, Metal-Oxide Gas Sensors, FET Sensors, Potentiometric Sensors, Amperometric Sensors, Acoustic Wave Sensors, Optical Sensors, and Piezoelectrical Sensors.

Along with the progress of technology, the chemical sensors have improved from the conventional ceramics material and the Screen Printing method to the semiconductor process and the Microelectromechanical System (MEMS); moreover, it even progresses to the advanced Nanotechnology. No matter what kinds of the chemical gas sensors are, the common key factor to the character of such chemical gas sensors is the sensing material. And many researchers of the chemical gas sensors have focused on the sensing material, especially the material component, for a long time.

Employing the semiconductor process and MEMS on chemical sensors manufacturing is a relatively fresh method both in industry and laboratory. With such technology, we can reduce the size of particles contained within the sensing material film, enlarge the surface square measure of the sensing area, decrease the operating temperature, and enhance the sensitivity. In fact, there have been several patents disclosing the related technology in wafer level chemical sensors, such as U.S. Pat No 5,948,361 and U.S. Pat No 6,023,091. However, it still suffers some problems, and the most challenge is to precisely put the sensing material into a certain location of the chip on the wafer. In the traditional manufacture process of chemical sensors, the common methods for locating sensing material are such as Screen Printing, Spin Coating, Chemical Vapor Deposition, and Sputtering. Please refer to FIG. 1, which is a schematic view of locating sensing material with Screen Printing method of the prior art. The interior devices 12 of the chemical sensor are formed on the substrate 11. Then through a patterned screen 13, the sensing material can be spread on certain locations of the chemical sensor chip thus providing the complete chemical sensor 14. However, in the wafer level chemical sensor, there are often floating film structures formed on the substrate which are too delicate to use the screen printing or spin coating method. Moreover, in the method of sputtering or spraying, most of the sensing materials will be removed directly in the process of lift-off or residue eliminating so as to increase the manufacture cost. Focusing on the wafer level chemical sensors, the present invention thus provides a method that uses a drip system to locate the sensing materials.

Besides, corresponding to such drip system for sensing material locating, the follow-up steps for dividing the chemical sensor chips also need to be designed. Please refer to FIG. 2, which is the schematic view showing the wafer cutting technology of the prior art. After the devices and layout patterns 22 formed on the wafer 21, there will be a passivation 23 deposited on the top layer, and the individual sensor chips 24 will thus be completed by using the laser cutting or wafer dicing machine. Such method requires water columns to cool down and remove byproducts, but the pressure thereof is so large as to damage the interior devices. In the chemical sensor process, the sensing material needs to be naked to contact the external environment. So when the water column is jetted into the surface of the sensor, the sensing material will be easily damaged or separated from the sensor. The present invention thus provides a method to modify the original sequence of the semiconductor process, which not only can protect the sensing material from external damaging but also can increase the rate of dividing chips and improve the yield.

### SUMMARY OF THE INVENTION

The primary object of the present invention is to provide a method for manufacturing chemical sensors, which can be employed in the wafer level chemical sensor manufacture thus precisely locating the sensing material onto the certain areas of chemical sensor chips.

The secondary object of the present invention is to provide a method for simultaneously filling several kinds of sensing material into chemical sensors thus providing multi-function chemical sensors.

The third object of the present invention is to provide a method for manufacturing chemical sensors, which corresponds to the manufacture process of wafer level chemical sensor to divide the wafer into individual chemical sensor chips without damaging the sensing materials located on the chip.

In order to achieve the aforesaid objects, the present invention provides a method including the following steps:
a) Proving a substrate formed with a plurality of chemical sensors in order.
b) Forming at least one frame on certain area of the chemical sensor, wherein the frame projecting from the surface of the chemical sensor thus providing a containing space.
c) Filling a Sol-Gel sensing material into the containing space.
d) Hardening the sensing material.
e) Dividing the plurality of chemical sensors on the substrate into individual chemical sensors.

In order to achieve the aforesaid objects, the present invention provides another method including the following steps:
a) Proving a substrate with relative an obverse side and a reverse side, wherein the obverse side formed with a plurality of chemical sensors and the reverse side covered with an adhesive object.
b) Forming a scribe line between any two of the chemical sensors, wherein the scribe line passing through the obverse side and the reverse side of the substrate thus penetrating the substrate.
c) Locating a Sol-Gel sensing material into a certain area on the chemical sensor.
d) Heating the substrate thus dividing the plurality of chemical sensors into individual chemical sensors.

In order to achieve the aforesaid objects, the present invention further provides another method including the following steps:
a) Proving a substrate with relative an obverse side and a reverse side, wherein the obverse side formed with a plurality of chemical sensors and the reverse side covered with a first adhesive object.
b) Forming a scribe line along the periphery of each the chemical sensor.
c) Locating a Sol-Gel sensing material into a certain area on the chemical sensor.
d) Removing the first adhesive object.
e) Heating the substrate to harden the Sol-Gel sensing material.
f) Covering the reverse side of the substrate with a second adhesive object.
g) Dividing the plurality of chemical sensors into individual chemical sensors.

### BRIEF DESCRIPTION OF THE DRAWINGS

FIG. 1 is the schematic view showing the Screen Printing method for locating the sensing material.

FIG. 2 is the schematic view showing the wafer cutting technology of the prior art.

FIG. 3A is the schematic view of the manufacturing process for wafer level chemical sensor.

FIG. 3B is the schematic view showing the frame for locating sensing material of the present invention.

FIG. 4A is the schematic view showing the actuating mode of the chemical material drip system of the method for manufacturing chemical sensors.

FIG. 4B is the schematic view showing the sensing material filled into the frame on the sensor surface.

FIG. 4C is the schematic view showing the different masks integrated into the same drip system thus providing the function of locating different sensing materials in the same sequence.

FIG. 5 is the schematic view showing the pre-cutting scribe line in the process of dividing chemical sensor chips of the present invention.

FIG. 6A is the schematic views showing the first embodiment of the method for dividing chemical sensor chips of the present invention.

FIG. 6B is the schematic views showing the second embodiment of the method for dividing chemical sensor chips of the present invention.

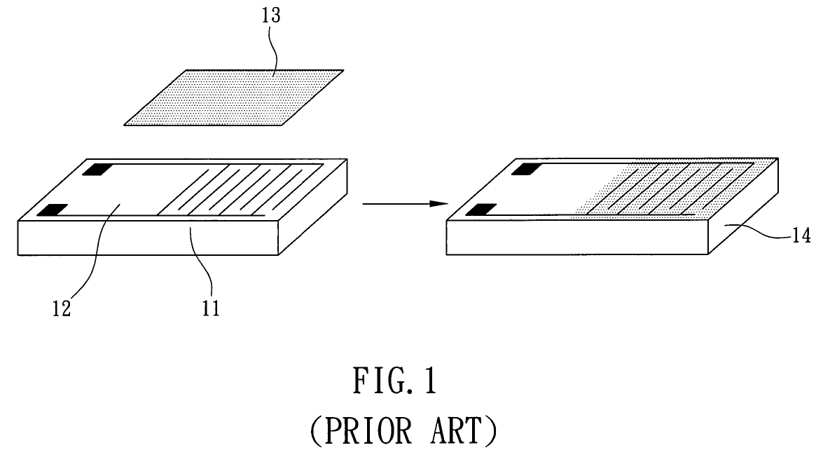

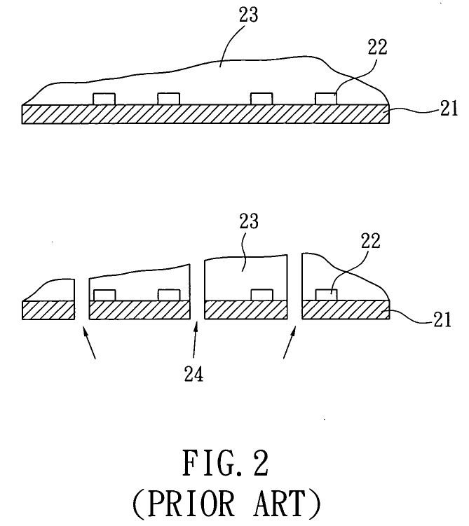

### DETAILED DESCRIPTION OF THE INVENTION

Matched with corresponding drawings, the preferable embodiments of the invention are presented as following and hope they will benefit your esteemed reviewing committee members in reviewing this patent application favorably.

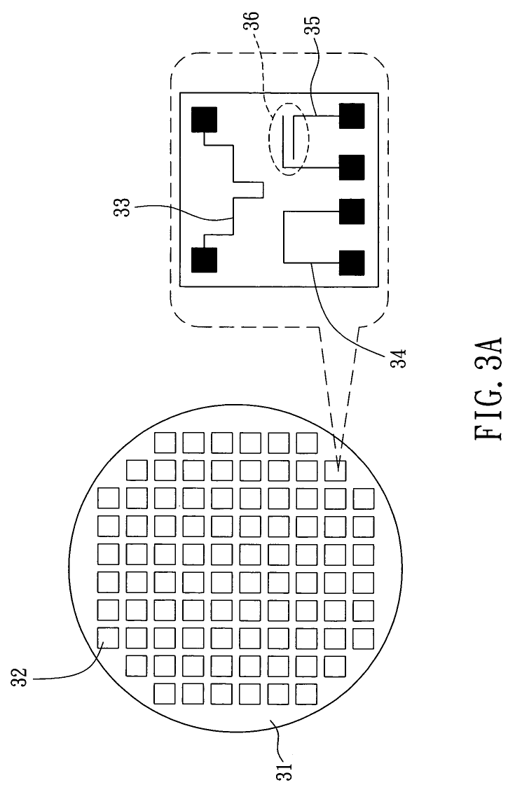

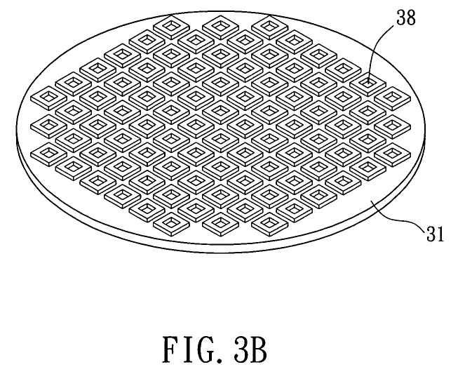

FIG. 3A is the schematic view showing the manufacturing process of the wafer level chemical sensor. Firstly, a substrate 31 is provided to form a plurality of the chemical sensors 32 with the technology of semiconductor process, surface micromachining, and bulk micromachining. Wherein the substrate 31 can be of the silicon wafer, glass, ceramic material, and all other heat-resistant materials. As shown in FIG. 3A, the chemical sensors 32 includes an electric conduction pad 33, a temperature sensor unit 34, and a heating unit 35 and the area surrounded by the dotted line 36 is the location of the sensing material.

After completing all the interior devices of the chemical sensor, as shown in FIG. 3B, a wall-like frame 38 is formed on the sensor surface along the dotted line 36. The frame 38 projects from the sensor surface thus providing a containing space for sensing material; wherein the height of the frame 38 is among 0.01 um ˜1000 um, and the shape of the surrounded area is arbitrary and not necessary to be sealed. Moreover, the manufacture method of the frame 38 can be photolithography, etching, deposition, press molding, injection molding, laser processing, or cutting processing, and the material thereof can be photoresist, metal, plastic material, or polymer.

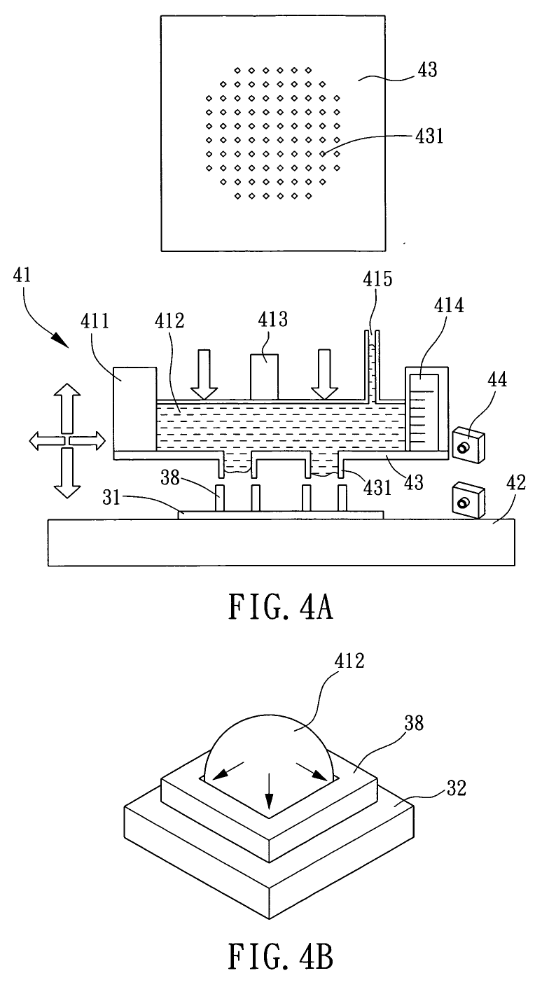

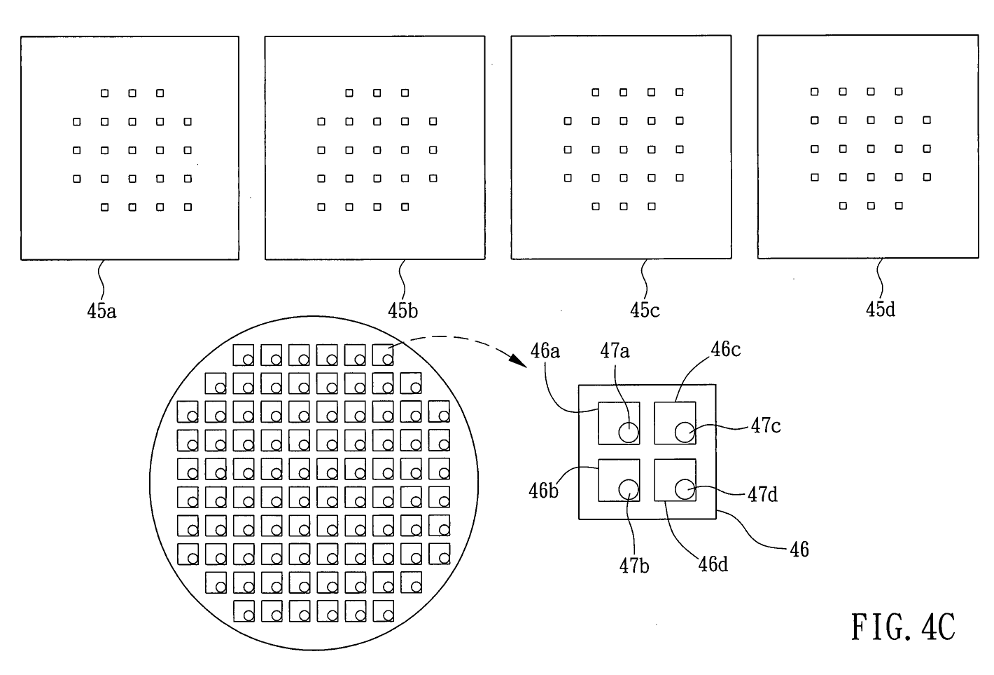

Then a sol-gel sensing material is provided to pour into a drip system, as shown in FIG. 4A, which is the schematic view showing the actuating of the drip system. The substrate 31 with the frame 38 formed thereon is located onto an operating platform 42, and a movable drip platform 41 is located above the substrate 31 with a certain distance. Wherein the movable drip platform 41 includes a holding framework 411, a delicate pressing system 413, a scale 414, and a sol-gel supplying system 415. Moreover, a mask 43 for imprinting the sensing material is fixed on the underneath of the movable drip platform 41 thus providing the entries for transmitting the sol-gel sensing material onto the frame 38 on the substrate 31. The mask 43 can be of metal, silicon wafer, glass, quartz, or polymer material. The space consisted of the holding framework 411 and the mask 43 is provided to carry the sensing material 412, which can be monitored the amount thereof by the scale 414 and replenished by the sol-gel supplying system 415 immediately. Corresponding to a precise aiming system, when the delicate pressing system 413 is actuated, the movable drip platform 41 can be arbitrary moved through auxiliary CCD or other optical mechanical contact system thus aiming the mask 43 at the frame 38. Then the sensing material 412 can be precisely filled into the area surrounded by the frame 38 via the dripping hole 431 of the mask 43, as shown in FIG. 4B. For the surface tension, the sol-gel sensing material is represented as half-ball type on the dripping hole 431. When the platform 41 is approaching to the frame 38, the sensing material 412 will fall from the dripping hole 431, and automatically fill of the frame as the platform 41 removed. Besides the aforesaid pressing method, we can also fill the sensing material purely by using the surface tension, capillary force, and gravity of the sensing material. In particular, the dripping hole 431 can be of arbitrary shape as either single hole or multi holes, and the pattern of the mask 43 is not necessary to wholly corresponding to the frame 38; however, the diameter of the dripping hole 431 is better to smaller than that of the frame 38 for conveniently filling the sensing material.

The character of the present invention is that several kinds of the sensing materials can be easily integrated in the same chip by using a designed mask, as shown in FIG. 4C. Firstly, the mask 45a is located on the drip system, and the sensing material 47a is filled into the frame 46a on the sensor chip 46 through the dripping platform. Then the mask 45b is located on the drip system, and the sensing material 47b is filled into the frame 46b on the sensor chip 46 through the dripping platform. Next, the mask 45c is located on the drip system, and the sensing material 47c is filled into the frame 46c on the sensor chip 46 through the dripping platform. Finally, the mask 45d is located on the drip system, and the sensing material 47d is filled into the frame 46d on the sensor chip 46 through the dripping platform. By such method, the different sensing materials can be filled into the chemical sensor in the same sequence and then calcined or furnaced together thus providing a economic method for producing multi-function chemical sensors and largely overcoming the disadvantage of the prior art that only provides single sensing material locating.

After the foregoing processes, the chemical sensors also need to be carried out the calcining or furnacing process to harden and fasten the sensing material and then divided into several individual chemical sensors.

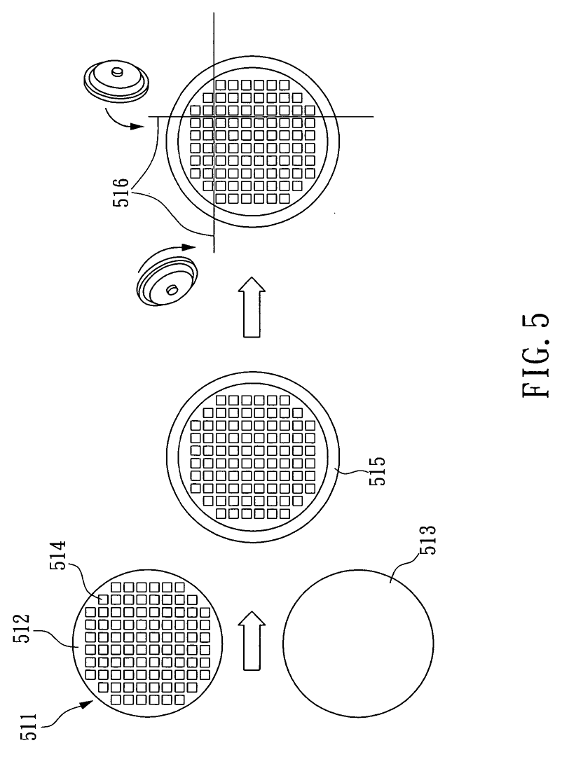

In traditional wafer chip dividing process, laser cutting method is usually employed after all processes are completed. Such method requires water columns to cool down and remove byproducts, but the pressure thereof is so large as to damage the interior devices. In the normal semiconductor manufacturing process, there is always a passivation deposited on the top layer for protection thus preventing the interior structures from being damaged. However, in the chemical sensor process, the sensing material needs to be naked to contact the external environment. So when the water column is jetted into the surface of the sensor, the sensing material will be easily damaged or separated from the sensor. To improve the practicability of the aforesaid method for manufacturing chemical sensor, the present invention also provides a new method for dividing chemical sensor chips. As shown in FIG. 5, a substrate 511 with relative an obverse side 512 and reverse side 513 is provided. On the obverse side 512 is a plurality of the chemical sensors 514 arranged in order, and on the reverse side 513 is an adhesive object that can be blue tape, UV tape, and so on. Then with the tradition scribe method in semiconductor process, scribe lines 516 are formed along the periphery of the chemical sensors. After the sensing material is filled into the chemical sensor and calcined or furnaced with the heater apparatus, the wafer with a plurality of the chemical sensors will be divided into several individual sensors. Depending on the different depths of the scribe line and the cutting sequence, the embodiments of the present invention can be classified as several types.

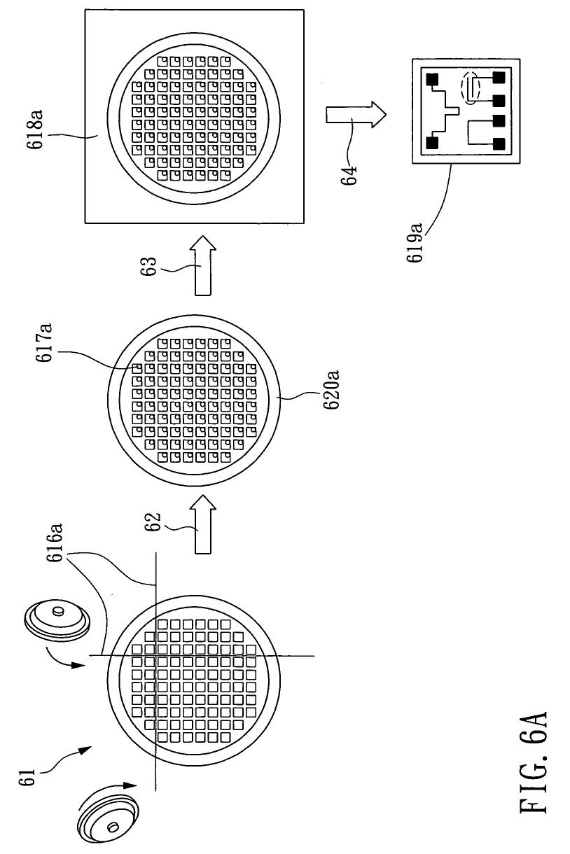

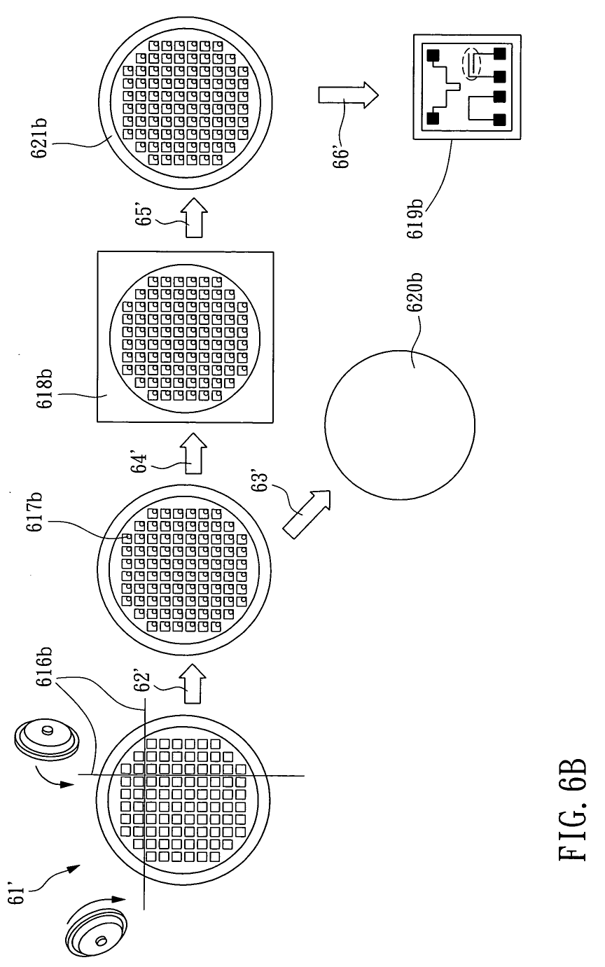

Please refer to FIG. 6A, which is the schematic view showing the steps of the first embodiment for dividing chemical sensor chips in the present invention:
Step 61: Forming a scribe line 616a along the periphery of each the chemical sensor by using the traditional semiconductor cutting technology, wherein the scribe line 616a passing through the obverse side and the reverse side of the substrate thus penetrating the substrate without cutting off the adhesion object 620a.
Step 62: Locating the sensing material into a certain area 617a on the chemical sensor with the method such as screen printing, spin coating, sputtering, and the aforesaid dripping method of the present invention.
Step 63: Heating for the process of calcining or furnacing to harden and fasten the sensing material; the heating temperature must be higher than the fusion point of the adhesion object and is among 100˜1000° C. thus burning the adhesion object to become ashes 618a.
Step 64: Cleaning the ashes to pick up the automatically divided chemical sensor chips

Please refer to FIG. 6B, which is the schematic view showing the steps of the second embodiment for dividing chemical sensor chips in the present invention without generating the ashes and particles in the process of calcining or furnacing:
Step 61′: Forming a scribe line 616b along the periphery of each the chemical sensor by using the traditional semiconductor cutting technology, wherein the scribe line 616a not penetrating the substrate.
Step 62′: Locating the sensing material into a certain area 617a on the chemical sensor with the method such as screen printing, spin coating, sputtering, and the aforesaid dripping method of the present invention.
Step 63′: Removing the adhesion object by using the method of solvent dissolving, optical dissolving, or external force stripping.
Step 64′: Heating for the process of calcining or furnacing 618b to harden and fasten the sensing material.
Step 65′: Pasting a second adhesion object 621b onto the reverse side of the substrate.
Step 66′: Cutting off the substrate along the scribe line thus dividing the wafer into several individual chemical sensor chips.

In Step 66′, the second adhesion object 621b is also divided into several pieces corresponding to the individual chemical sensor chips, and can be removing by using the method of solvent dissolving, optical dissolving, or external force stripping. Besides, in another preferred embodiment, the second adhesion object 621b can be removed by using the method of solvent dissolving, optical dissolving, or external force stripping after step 65′.

In summary, from the structural characteristics and detailed disclosure of each embodiment according to the invention, it sufficiently shows that the invention has progressiveness of deep implementation in both objective and function, also has the application value in industry, and it is an application never seen ever in current market and, according to the spirit of patent law, the invention is completely fulfilled the essential requirement of new typed patent.

1. A method for manufacturing chemical sensors, and the steps of the method includes:
a) Proving a substrate formed with a plurality of chemical sensors in order.
b) Forming at least one frame on certain area of the chemical sensor, wherein the frame projecting from the surface of the chemical sensor thus providing a containing space.
c) Filling a Sol-Gel sensing material into the containing space.
d) Hardening the sensing material.
e) Dividing the plurality of chemical sensors on the substrate into individual chemical sensors.

2. The method for manufacturing chemical sensors recited in claim 1, wherein the material of the substrate in step a can be chosen from the set of silicon wafer, quartz, glass, and ceramic material.

3. The method for manufacturing chemical sensors recited in claim 1, wherein the method for manufacturing the frame in step b can be chosen from the set of etching, deposition, press molding, injection molding, laser processing, and cutting processing.

4. The method for manufacturing chemical sensors recited in claim 1, wherein the mechanism for filling the sensing material into the containing space in step c can be chosen from the set of surface tension, capillary force, ejecting force, and external force.

5. The method for manufacturing chemical sensors recited in claim 1, wherein the Sol-Gel sensing material is filled into the containing space through a drip system.

6. The method for manufacturing chemical sensors recited in claim 5, wherein the drip system includes:
a movable drip platform;
at least one mask, located on the below of the movable drip platform; a operating platform, under the mask with a certain distance; and
a precise aiming system, installed respectively on the movable drip platform and the operating platform, for controlling the relative movement between the movable drip platform and the operating platform.

7. The method for manufacturing chemical sensors recited in claim 6, wherein a containing space formed of the movable drip platform and the mask can be used to fill the Sol-Gel sensing material.

8. The method for manufacturing chemical sensors recited in claim 6, wherein the operating platform is used to fix the substrate.

9. The method for manufacturing chemical sensors recited in claim 6, wherein the mask includes a plurality of dripping holes with certain arrangement in order to form entries for filling the sensing material into the chemical sensor.

10. The method for manufacturing chemical sensors recited in claim 6, wherein the mechanism of the precise aiming system can be chosen from the set of auxiliary CCD and optical mechanical contact system.

11. A method for manufacturing chemical sensors, and the steps of the method includes:
a) Proving a substrate with relative an obverse side and a reverse side, wherein the obverse side formed with a plurality of chemical sensors and the reverse side covered with an adhesive object.
b) Forming a scribe line between any two of the chemical sensors, wherein the scribe line passing through the obverse side and the reverse side of the substrate thus penetrating the substrate.
c) Locating a Sol-Gel sensing material into a certain area on the chemical sensor.
d) Heating the substrate thus dividing the plurality of chemical sensors into individual chemical sensors.

12. The method for manufacturing chemical sensors recited in claim 11, wherein the adhesive object can be chosen from the set of blue tape and UV tape.

13. The method for manufacturing chemical sensors recited in claim 11, wherein the method for locating the Sol-Gel sensing material into a certain area on the chemical sensor in step c can be chosen form the set of screen printing, coating, sputtering, and dripping.

14. A method for manufacturing chemical sensors, and the steps of the method includes:
a) Proving a substrate with relative an obverse side and a reverse side, wherein the obverse side formed with a plurality of chemical sensors and the reverse side covered with a first adhesive object.
b) Forming a scribe line along the periphery of each the chemical sensor.
c) Locating a Sol-Gel sensing material into a certain area on the chemical sensor.
d) Removing the first adhesive object.
e) Heating the substrate to harden the Sol-Gel sensing material.
f) Covering the reverse side of the substrate with a second adhesive object.
g) Dividing the plurality of chemical sensors into individual chemical sensors.

15. The method for manufacturing chemical sensors recited in claim 14, wherein the adhesive object can be chosen from the set of blue tape and UV tape.

16. The method for manufacturing chemical sensors recited in claim 14, wherein the scribe line in step b did not penetrate the substrate.

17. The method for manufacturing chemical sensors recited in claim 14, wherein the method for locating the Sol-Gel sensing material into a certain area on the chemical sensor in step c can be chosen form the set of screen printing, coating, sputtering, and dripping.

18. The method for manufacturing chemical sensors recited in claim 14, wherein the method for removing the first adhesive object in step d can be chosen form the set of solvent dissolving, optical dissolving, and external force stripping.

19. The method for manufacturing chemical sensors recited in claim 14, wherein in step g the second adhesive object is also divided into several pieces corresponding to the individual chemical sensors, and then removed by the method chosen from the set of solvent dissolving, optical dissolving, and external force stripping.

20. The method for manufacturing chemical sensors recited in claim 14, wherein the method further includes a step f′ after the step f:
f′) removing the second adhesive object by the method chosen from the set of solvent dissolving, optical dissolving, and external force stripping.
